(19) United States
(12) Patent Application Publication
(10) Pub. No.: US 2013/0009984 A1
(43) Pub. Date: Jan. 10, 2013

(54) DISPLAY INSTALLED IN HALL

(75) Inventor: Nobuo KAWAKAMI, Tokyo (JP)

(73) Assignee: DWANGO CO., LTD., Tokyo (JP)

(21) Appl. No.: 13/540,890

(22) Filed: Jul. 3, 2012

(30) Foreign Application Priority Data
Jul. 8, 2011 (JP) 2011-152317

(51) Int. Cl. G09G 5/00

(52) U.S. Cl. 345/619

(57) ABSTRACT

It is an objective to provide a display system installed in hall for displaying avatars at an event hall as a real space, and for appropriately displaying such avatar at the event hall according to the number of users who wish to display the avatar. We provide a display system, that is installed in a hall for live performance etc. and displays an avatar appearing as an audience outside, the system, comprising a display for displaying the avatar, a first receiver for receiving a display signal for avatar from a viewer terminal or a peripheral device for viewer terminal, an acquisition unit for number of avatars to be displayed, acquiring number of avatars to be displayed on the display on a basis of the received display signal for avatar, and a controller for an appearance of avatar to be displayed on the display according to the acquired number of avatars to be displayed.

### BACKGROUND OF THE INVENTION

1. Field of the Invention

The present invention relates to a display system being installed in a hall for live performances etc, and displaying an avatar appearing as an audience outside the hall.

2. Description of the Related Art

Recently, a technology for having an avatar as a virtual self of a user coming out in a virtual space on the network, thereby enabling communications and enjoying games through other avatars, or simulating an experience of a trip etc. has been presented.

For example, in Japanese Unexamined Patent Application Publication No. 2007-328389, an invention providing a virtual study room, where a plurality of users can enter through the network, is disclosed. The user makes his avatar enter the study room, so that the user can see a virtual scene, where others are using avatars for study at a desk, thereby motivating the user to study.

### RELATED ART DOCUMENTS

Patent Document 1: Japanese Unexamined Patent Application Publication No. 2007-328389

As described above, by having the simulated action and experience through the avatar, the user can achieve a sense of satisfaction. However, from a remote location, the user cannot fulfill his wish to get involved in a concert, an event, or a festival, which are held in the real world. This is a result of the space where the avatar can appear being limited to virtual space. Therefore, in the conventional technology, there is no approach to cause the avatar to appear in the real space such as an event hall. Accordingly, a technology for displaying the avatars in the real space such as the event hall, and appropriately displaying such avatars in the hall according to the number of users who wish the avatars to appear is demanded.

### SUMMARY OF THE INVENTION

In order to solve the above deficiencies, the following display system installed in a hall is provided. A first aspect of the present invention is a display system installed in hall that is a display system being installed in a hall for live performance etc, and displaying an avatar appearing as an audience outside, the system, comprising a display, displaying an avatar; a first receiver, receiving a display signal for avatar from a terminal for viewing or a peripheral device for the terminal for viewing; an acquisition unit for number of avatars to be displayed, acquiring number of avatars to be displayed on the display on a basis of the received display signal for avatar; and a controller for appearance, controlling an appearance of the avatar to be displayed on the display according to the acquired number of avatars to be displayed.

A second aspect of the present invention is a display system installed in hall that is a display system being installed in a hall for live performance etc, and displaying an avatar appearing as an audience outside, the system, comprising a display, displaying an avatar; a management unit for issuance of ticket, managing an issuance of a ticket for viewing an image including the live performance in the hall; a second receiver, receiving a display signal for avatar from the management unit for issuance of ticket; an acquisition unit for number of avatars to be displayed, acquiring number of avatars to be displayed on the display on a basis of the received display signal for avatar; and a controller for appearance, controlling an appearance of the avatar to be displayed on the display according to the acquired number of avatars to be displayed.

A third aspect of the present invention is the display system installed in hall according to the first or second aspect, further comprising a live transmitter, simultaneously transmitting the image of the live performance etc. in the hall to the terminal for viewing.

A fourth aspect of the present invention is the display system installed in hall according to any one of the first to third aspects, wherein the display signal for avatar includes the time information for displaying the avatar, further comprising a controller for display time, controlling display time of the avatar by utilizing time information,

A fifth aspect of the present invention is the display system installed in hall according to any one of the first to fourth aspects, further comprising a controller for display time according to priority, controlling display time of the avatar by utilizing priority information, wherein the display signal for avatar includes the priority information for displaying the avatar.

A sixth aspect of the present invention is the display system installed in hall according to any one of the first to fifth aspects, further comprising a controller for display time according to sequence, controlling display time of the avatar on a basis of a sequence of receiving the display signal for avatar.

A seventh aspect of the present invention is a method for operating a display system that displays an avatar appearing as an audience outside on a display being installed in a hall for live performance etc, the method causing a computer to execute a process, comprising receiving a display signal for avatar from a terminal for viewing or a peripheral device for the terminal for viewing; acquiring number of avatars to be displayed on the display on a basis of the received display signal for avatar; and controlling an appearance of the avatar to be displayed on the display according to the acquired number of avatars to be displayed.

An eighth aspect of the present invention is a method for operating a display system that displays an avatar appearing as an audience outside on a display being installed in a hall for live performance etc, and comprises a management unit for issuance of ticket, managing an issuance of a ticket for viewing an image including the live performance in the hall, the method causing a computer to execute a process, comprising receiving a display signal for avatar from the management unit for issuance of ticket; acquiring number of avatars to be displayed on the display on a basis of the received display signal for avatar; and controlling an appearance of the avatar to be displayed on the display according to the acquired number of avatars to be displayed.

A ninth aspect of the present invention is a computer-readable storage medium storing a program for causing a computer to execute a process of operating a display system that displays an avatar appearing as an audience outside on a display being installed in a hall for live performance etc, the program comprising receiving a display signal for avatar from a terminal for viewing or a peripheral device for the terminal for viewing; acquiring number of avatars to be displayed on the display on a basis of the received display signal for avatar; and controlling an appearance of the avatar to be displayed on the display according to the acquired number of avatars to be displayed.

A tenth aspect of the present invention is a computer-readable storage medium storing a program for causing a computer to execute a process of operating a display system that displays an avatar appearing as an audience outside on a display being installed in a hall for live performance etc, and comprises a management unit for issuance of ticket, managing an issuance of a ticket for viewing an image including the live performance in the hall, the program comprising receiving a display signal for avatar from the management unit for issuance of ticket; acquiring number of avatars to be displayed on the display on a basis of the received display signal for avatar; and controlling an appearance of the avatar to be displayed on the display according to the acquired number of avatars to be displayed.

According to the present invention having the above configuration, the avatar appearing as the viewer is displayed in the hall, where the live performance is actually held, so that the viewer can get the feeling that the viewer is at the hall and participating in the event.

### BRIEF DESCRIPTION OF THE DRAWINGS

FIG. 1 is a conceptual diagram of a display system installed in hall of a first embodiment.

FIG. 2 is a functional block diagram of the display system installed in hall of the first embodiment.

FIG. 3 is a conceptual diagram of a display system installed in hall of a first embodiment.

FIG. 4 is a diagram exemplifying a table for correlating a number of avatars to be displayed and an appearance of an avatar.

FIG. 5 is a diagram exemplifying a table for correlating a number of avatars to be displayed and an appearance of an avatar.

FIG. 6 is a diagram exemplifying a hardware configuration of the display system installed in hall of the first embodiment.

FIG. 7 is a flowchart of the display system installed in hall of the first embodiment.

FIG. 8 is a functional block diagram of a display system installed in hall of a second embodiment.

FIG. 9 is a functional block diagram of a display system installed in hall of a third embodiment.

FIG. 10 is a functional block diagram of a display system installed in hall of a fourth embodiment.

FIG. 11 is a flowchart of the display system installed in hall of the fourth embodiment.

FIG. 12 is a functional block diagram of a display system installed in hall of a fifth embodiment.

FIG. 13 is a functional block diagram of a display system installed in hall of a sixth embodiment.

### DESCRIPTION OF THE PREFERRED EMBODIMENTS

Embodiments of the present invention will be described hereinafter. The first embodiment will mainly describe Claim 1. The second embodiment will mainly describe Claim 2. The third embodiment will mainly describe Claim 3. The fourth embodiment will mainly describe Claim 4. The fifth embodiment will mainly describe Claim 5. The sixth embodiment will mainly describe Claim 6. The present invention is not to be limited to the above embodiments and able to be embodied in various forms without departing from the scope thereof.

### First Embodiment

### Outline of First Embodiment

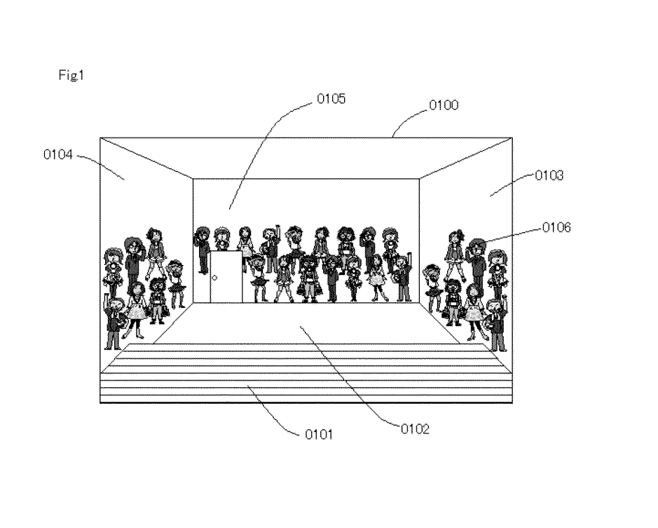

FIG. 1 is a conceptual diagram of a display system installed in hall of a first embodiment. A hall (0100) is a facility, where live performance is actually held, and FIG. 1 shows a box-shaped indoor hall. Moreover, FIG. 1 shows a scene viewed from a stage (0101) to a floor (0102) providing a space for the audience. Viewing from the stage, a display (0103) is placed on the entire right side wall, and a display (0104) is also placed on the entire left side wall. Moreover, a display (0105) is placed on the entire back side wall.

In these displays, an avatar (0106) is displayed. Moreover, an appearance such as size and shape of the avatar is appropriately varied according to number of users who wish to display the avatar. For example, when the number is relatively small, each avatar is displayed in a large size. Meanwhile, when the number is relatively large, each avatar is displayed in a small size.

Thus, the avatar appearing as the viewer outside the hall, where the live performance is actually held, is displayed on the display as if it is an audience, so that the viewer can get the feeling that the viewer is at the hall and participating in the event. Moreover, when shooting the scene of the hall, receiving it by the user's terminal for viewing, and viewing the display of the user's avatar, the user's feeling that he is at the hall and participating in the event is enhanced.

### Configuration of First Embodiment

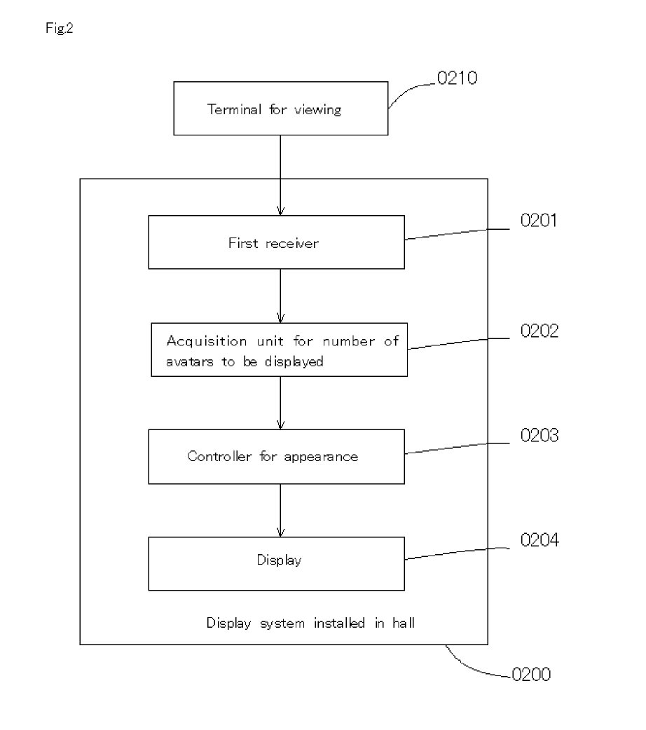

FIG. 2 is a functional block diagram of the display system installed in hall of the first embodiment. A ‘display system installed in hall’ (0200) comprises a ‘first receiver’ (0201), an ‘acquisition unit for number of avatars to be displayed’ (0202), a ‘controller for appearance’ (0203), and a ‘display’ (0204).

Note that, the functional block of the first embodiment can be implemented by hardware, software, or both hardware and software. Specifically, in the case of using a computer, examples of the above include the hardware configured by a CPU, a RAM, a bus, a secondary storage device (e.g., a nonvolatile memory, a storage media such as a memory card, or a reader/writer for such media), a display device, and other peripheral devices, and I/O port for the peripheral devices; and a driver program for controlling the above hardware, other application programs; and a user interface used for inputting information.

The CPU executes operation in accordance with the program developed on the main memory, so that processing, storing and outputting of the data, inputted through the input device or the interface etc. and stored in the memory of the hard disk, carried out, and instructions to control the hardware and software are generated.

Moreover, the above hardware and software are utilized for computing the program developed on the RAM by the CPU, for processing, storing and outputting of the data, stored in a memory or the hard disk or inputted through the interface, or for controlling the respective hardware components. Moreover, the present invention can be implemented not only as an apparatus but also as a method thereof. Moreover, a portion of such inventions may be configured as software. Furthermore, a software product used for causing a computer to execute the software, and the recording medium, in which the software is installed, should be included in the technical scope of the present invention (the same applies throughout the entire specification).

The ‘display system installed in hall’ (0200) is a display system being installed in a hall for live performances etc. and displaying an avatar appearing as an audience outside the hall. The ‘hall for live performance etc.’ is a hall where some events such as a live performance are held, and examples of the hall include a concert hall or a theatre. Moreover, an outdoor hall may be included in addition to the indoor hall. Moreover, in addition to the music event, examples of the event include games of baseball or football, and festivals.

The ‘audience outside the hall’ is a person who does not go to the event hall, and who can view a scene of the event in the hall through some kind of method currently or in the future. Examples of the method for viewing include live movie distribution via Internet, VOD (Video On Demand), live broadcast of baseball or football, and news broadcast reporting a festival. Moreover, the display system is provided with a function of simultaneously transmitting the live performance etc. in the hall, thereby making the live performance etc. viewable even outside the hall. Moreover, by accessing to a movie distribution server, independent from the display system installed in hall, it is possible to view the live performance etc.

The ‘avatar’ is an ‘incarnation’ or a ‘representation’ of oneself, conceptually. More specifically, the avatar is a representation of an audience outside the hall. In addition to a human figure, examples of appearances of the avatar include an animal, a flower wreath, and an icon image. The appearance of the avatar may be correlated with identification information for identifying the audience, and stored. A plurality of appearances of the avatar correlated with the identification information may be used.

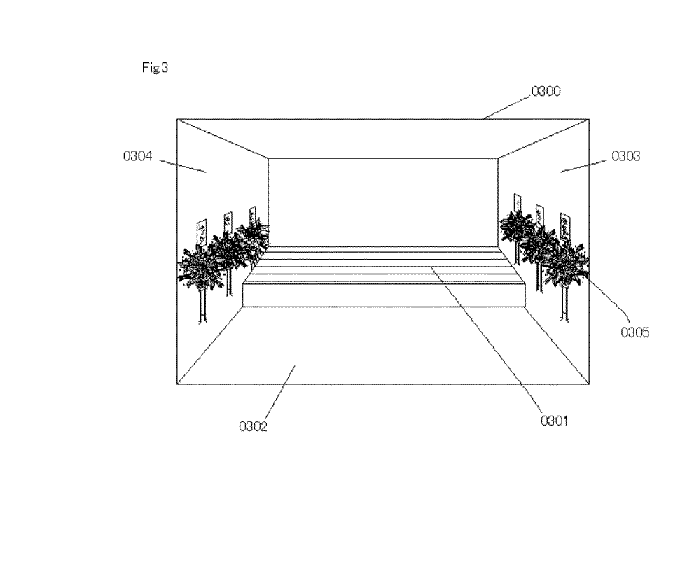

FIG. 3 is a conceptual diagram showing flower wreaths for celebration are displayed as the avatars. FIG. 3 shows a scene viewed from a floor (0302) to a stage (0301). Flower wreaths (0305) are displayed as avatars on displays (0303 and 0304) placed on the right and left walls facing the stage. On the flower wreath, a label indicating a name or a nickname such as ‘Muck’ or ‘Miyochan’, which can be identified as ones name or nickname, is attached.

Viewing from the stage, display (0103) is placed on the entire right side wall, and a display (0104) is also placed on the entire left side wall. Moreover, a display (0105) is placed on the entire back side wall. Thus, by displaying the flower wreath as the avatar, the user can express his emotion of cheering a performer of the live performance in the hall, or can feel that he is participating in the live performance without going to the hall.

The ‘first receiver’ (0201) has a function of receiving a display signal for avatar from a terminal for viewing or a peripheral device for the terminal for viewing. The ‘terminal for viewing’ has a function of receiving and viewing the live distribution or broadcast, and is a terminal having a function of transmitting the after-mentioned display signal for avatar. Examples of the terminal include a personal computer, a tablet computer, a television receiver, and a mobile phone. The ‘peripheral device of terminal for viewing’ is a device, which is used by being connected with the terminal for viewing through wired or wireless communication. Examples of the device include a mouse and a portable music player. The transmission of the display signal for avatar may be carried out by a function of the connected terminal for viewing, or by providing the peripheral device of terminal for viewing with a function of transmitting the signal. Moreover, a lighting instrument called as ‘concert light’ etc, which is used in a concert hall etc, may be provided with the function of transmitting the signal. Examples of the lighting instrument called as concert light etc. include an instrument with fluorescent by chemiluminescence, and an instrument with LED in place of the chemiluminescence.

The ‘display signal for avatar’ is a signal to request for displaying the avatar on the display. The display signal for avatar includes at least information to specify live performance etc, where the avatar is requested to be displayed, and may include information to specify an appearance of the avatar to be displayed. An example of the signal includes a signal to request that ‘avatar appearing as the user’ is displayed in the hall for ‘Yamada Taro's concert held on May 20, 2012’.

Note that the request for displaying the avatar is not limited to the request proactively made by the viewer. For example, the request may be automatically made by making a reservation of viewing the live performance.

The transmission of the display signal for avatar may be carried out through the internet or telecommunication line etc. When transmitting the display signal for avatar, the appearance of the avatar to be displayed may be selected or edited. Moreover, when a plurality of avatars correlated with the identification information of the viewer have already been stored, it is possible to select the avatar.

The transmission of the display signal for avatar may be preliminarily carried out before the live performance where the avatar is to be displayed, or in the middle of viewing the performance.

The ‘acquisition unit for number of avatars to be displayed’ (0202) has a function of acquiring number of avatars to be displayed on the display on a basis of the received display signal for avatar. The number of the received display signals for avatar may be acquired as the number of avatars, or the number of avatars to be displayed may be acquired from information to specify the avatar included in the received display signal for avatar.

The ‘controller for appearance’ (0203) has a function of controlling the appearance of the avatar to be displayed on the display according to the acquired number of avatars to be displayed. The ‘appearance of avatar’ includes shape, size and color of an avatar. An area of the display to be installed in the hall is naturally limited. Therefore, according to the number of the avatars to be displayed, the size of the avatar is increased or reduced in order to carry out an adjustment between the area size and the number of the avatars to be displayed. Thus, the appearance of the avatar is controlled according to the number of avatars to be displayed of the avatars, for example, thereby displaying all of the avatars to be displayed on the display.

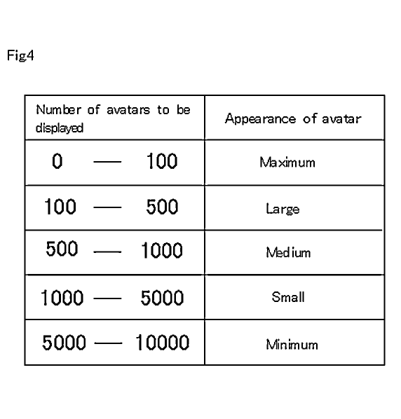

The controller for appearance can control the appearance of the avatar with reference to a table, where the number of avatars to be displayed and the appearance of the avatar according to the number of avatars to be displayed are correlated. FIG. 4 shows an example of such table. The number of avatars to be displayed is segmented in incremental steps such as ‘0-100’, ‘501-1000’, ‘1001-5000’, and ‘5001-10000’, and the avatar appearance corresponding to the respective numbers of avatars to be displayed is made to be smaller from ‘maximum’ to ‘minimum’ in incremental steps.

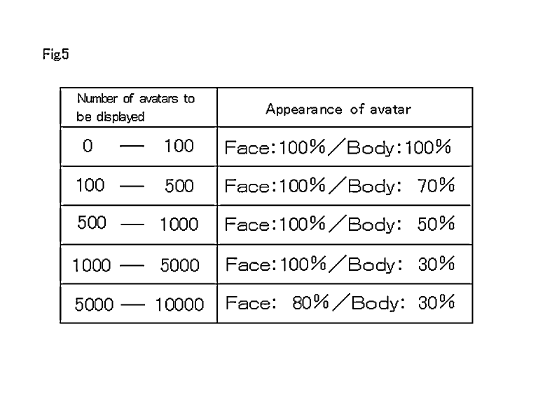

FIG. 5 is a diagram exemplifying a table for correlating a number of avatars to be displayed and an appearance of an avatar. Although the segment of the number of avatars to be displayed is the same as that of FIG. 4, the appearance is controlled according to percentages of the displayed face and body. When displaying both face and body at 100%, an entire body of the avatar is displayed. When displaying the face at 100% and the body at 30%, the avatar's face is displayed at 100%, and the avatar's body is displayed only at 30%. The terms ‘displayed only at 30%’ means that a part of the avatar overlaps with the other avatars, and 70% of the avatar's body is hidden and not displayed, similar to a case when taking a memorial photo of a large group, one's face may appear from over the shoulders of another persons. It is preferable to display an area such as a face, which is easily recognized as oneself, without deleting, when partially deleting the avatar as above.

### Hardware Configuration of First Embodiment

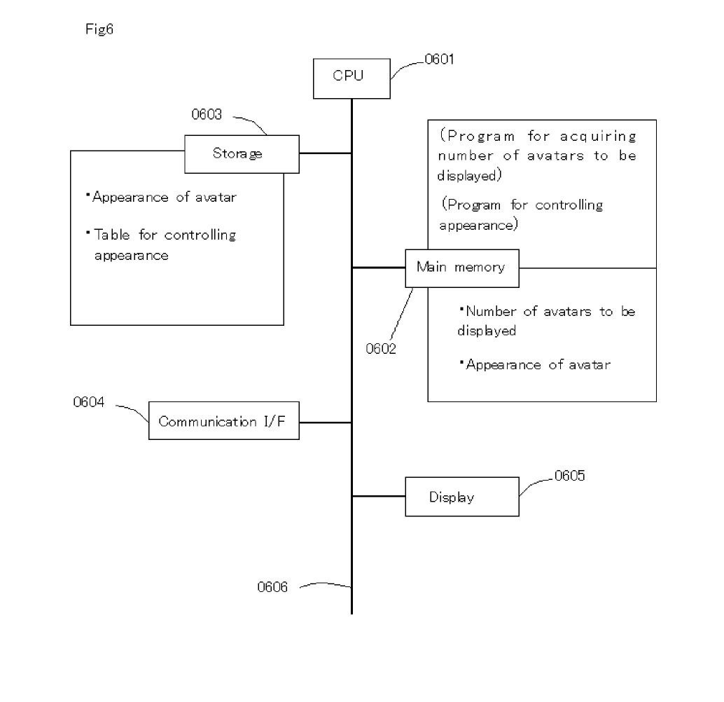

FIG. 6 is a diagram exemplifying a hardware configuration of the display system installed in hall of the first embodiment.

As shown in FIG. 6, the display system installed in hall comprises a ‘CPU’ (0601) and a ‘main memory’ (0602) for executing various calculations, thereby configuring the acquisition unit for number of avatars to be displayed and the controller for appearance. Moreover, the display system comprises a ‘storage’ (0603) for storing the table for controlling appearance, where the number of avatars to be displayed of the avatar and the avatar's appearance are correlated, a ‘communication I/F’ (0604) for implementing the first receiver, a ‘display’ (0605) for displaying an avatar. Moreover, the above components are mutually connected with each other through a data communication path such as a ‘system bus’ (0606), thereby carrying out transmission/reception and processing of information.

In the ‘main memory’, programs are developed, and the ‘CPU’ refers to the program and executes the various calculations in accordance with a process in the program. Moreover, a plurality of addresses are assigned to the ‘main memory’ and the ‘memory’, and in the calculation by the ‘CPU’, address specification and access to the stored data are carried out, thereby executing calculation by utilizing the data.

In the display system installed in hall, the display signal for avatar is received from the terminal for viewing or peripheral device for the terminal for viewing through the ‘communication I/F’. Subsequently, the ‘CPU’ executes a program for acquiring number of avatars to be displayed, thereby acquiring the number of avatars to be displayed. The acquired number of avatars to be displayed is stored at a predetermined address. Subsequently, the CPU executes a program for controlling appearance, thereby acquiring the appearance of avatar correlated with the acquired number of avatars to be displayed with reference to the table for controlling appearance, and displaying the avatar on the display.

### Processing Flow of First Embodiment

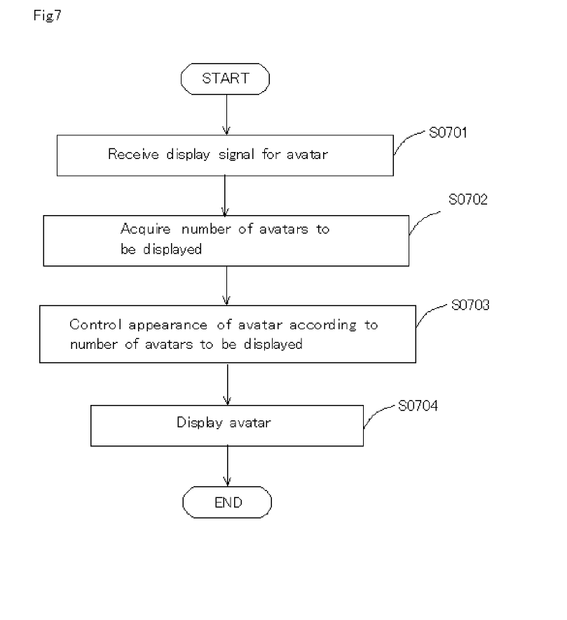

FIG. 7 is a flowchart of the display system installed in hall of the first embodiment. Note that, the following step may be executed by the respective hardware configurations of a computer as above, or may configure a program, which is stored in a medium and is for controlling the computer.

As shown in FIG. 7, at the outset, the display signal for avatar is received from the terminal for viewing or peripheral device for the terminal for viewing (step S0701). The display signal for avatar may be received from a management server for access for managing identification information of a viewer accessing to the live event held at the hall. Subsequently, the number of the avatars to be displayed on the display is acquired on the basis of the received display signal for avatar (step S0702). The acquisition of the number of avatars to be displayed may be carried out on the basis of the number of the display signals for avatar, or on the basis of information to specify the avatar included in the received display signal for avatar. Subsequently, the appearance of the avatar to be displayed on the display according to the acquired number of avatars to be displayed is controlled (step S0703). Subsequently, the avatar with the controlled appearance is displayed on the display (step S0704).

### Effects of First Embodiment

According to the first embodiment, it is possible to display the avatar with appearance appropriately controlled according to the number of avatars to be displayed when displaying the viewer's avatar at the hall where a live performance etc. is held.

### Second Embodiment

### Outline of Second Embodiment

A display system installed in hall of a second embodiment issues a ticket for viewing an image including a live performance etc. in the hall, and acquires the number of avatars to be displayed according to the number of the issuances.

### Configuration of Second Embodiment

The second embodiment has a configuration partially different from that of the display system installed in hall of the first embodiment, and other components are the same as those of the first embodiment.

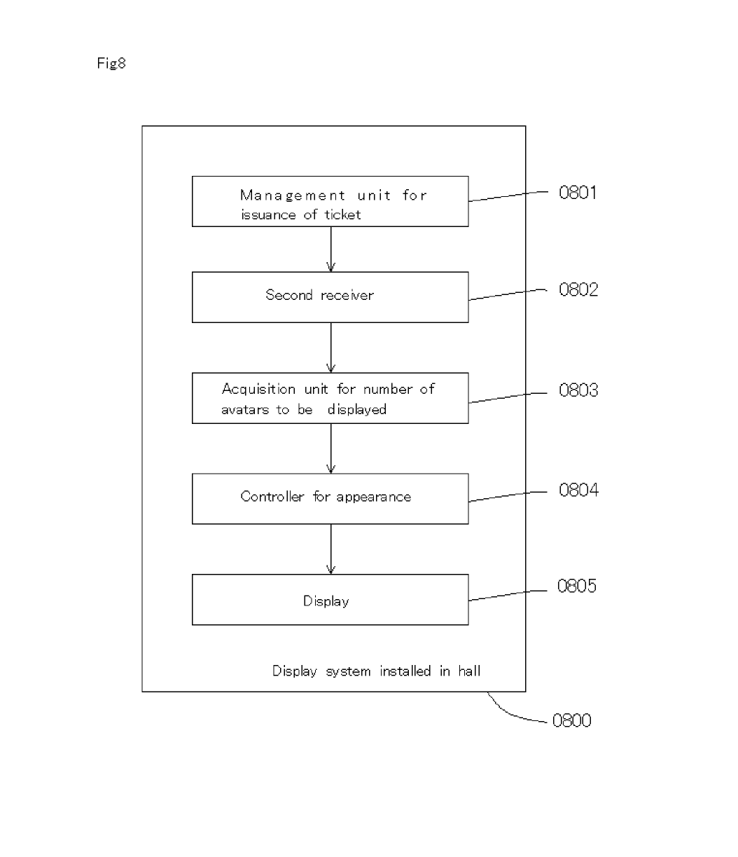

FIG. 8 is a functional block diagram of the display system installed in hall of the second embodiment. A ‘display system installed in hall’ (0800) comprises a ‘management unit for issuance of ticket’ (0801), a ‘second receiver’ (0802), an ‘acquisition unit for number of avatars to be displayed’ (0803), a ‘controller for appearance’ (0804), and a ‘display’ (0805).

The ‘management unit for issuance of ticket’ (0801) has a function of managing an issuance of a ticket for viewing an image including the live performance in the hall.

Examples of the ‘image including the live performance in the hall’ include an image distributed or broadcasted through the Internet.

The ‘ticket’ is a voucher, which indicates fulfillment of a predetermined requirement for making an image viewable, and includes an electric voucher. Examples of the voucher include an admission ticket issued for payment of fare, and a membership registration for membership-based movie distribution service. Examples of the payment of fare include payment by cash and payment by credit card. Moreover, the membership registration is not limited to charged procedure, and may be free.

The ‘management of issuance of ticket’ means management of the number of issuances of the above admission ticket, the number of purchases of paid broadcast contents, or the number of members of distribution service etc. Moreover, the issuance number may be correlated with identification information of the viewer holding a ticket, and managed.

The management of issuance of ticket has a function of transmitting the display signal for avatar to the after-mentioned second receiver. This display signal for avatar is basically the same as that of the display signal for avatar of the first embodiment, and is a signal to request for displaying the avatar on the display.

The management of issuance of ticket acquires information as to whether the viewer wishes display of the avatar upon issuance of the ticket, thereby generating the display signal for avatar to be transmitted. Moreover, the display signal for avatar may be generated on the assumption that all the viewers wish to display the avatars.

The ‘second receiver’ (0802) has a function of receiving a display signal for avatar from the management unit for issuance of ticket. The second receiver has the same configuration as that of the ‘first receiver’ of the first embodiment with the exception of receiving the display signal for avatar from the management of issuance of ticket. Accordingly, a description thereof has been omitted.

The ‘acquisition unit for number of avatars to be displayed’ (0803) has a function of acquiring number of avatars to be displayed on the display on a basis of the received display signal for avatar, and has the same configuration as that of the ‘acquisition unit for number of avatars to be displayed’ of the first embodiment. Accordingly, a description thereof has been omitted.

The ‘controller for appearance’ (0804) has a function of controlling an appearance of the avatar to be displayed on the display according to the acquired number of avatars to be displayed, and has the same configuration as that of the ‘controller for appearance’ of the first embodiment. Accordingly, a description thereof has been omitted.

The ‘display’ (0805) has a function of displaying an avatar, and has the same configuration as that of the ‘display’ of the first embodiment. Accordingly, a description thereof has been omitted.

### Hardware Configuration of Second Embodiment

The display system installed in hall of the second embodiment can be implemented by the hardware configuration described in the first embodiment. Accordingly, a description thereof has been omitted.

### Processing Flow of Second Embodiment

In the processing flow of the second embodiment, at the outset, the display signal for avatar is received from the management of issuance of ticket. The management of issuance of ticket, for example, acquires the information as to whether the viewer wishes display of the avatar upon issuance of the ticket, thereby generating and transmitting the display signal for avatar. Moreover, in the management server for registered members, the display signal for avatar may be generated and transmitted on the basis of the number of registrations of members, permitted to receive the distribution of image of live performance etc. Thus, the processing flow is the same as that of the first embodiment with the exception of the step of receiving the display signal for avatar from the management of issuance of ticket. Accordingly, a description thereof has been omitted.

### Effects of Second Embodiment

According to the second embodiment, it is possible to acquire the number of avatars to be displayed from the number of tickets issued for viewing through the terminal for viewing, thereby displaying the avatar with appearance appropriately controlled according to the number of avatars to be displayed.

### Third Embodiment

### Outline of Third Embodiment

In a display system installed in hall of a third embodiment, the image of the live performance etc. in the hall is transmitted to the terminal for viewing, so that the viewer can view the live performance etc. in real time.

### Configuration of Third Embodiment

The display system installed in hall of the third embodiment is on the basis of the first and second embodiments.

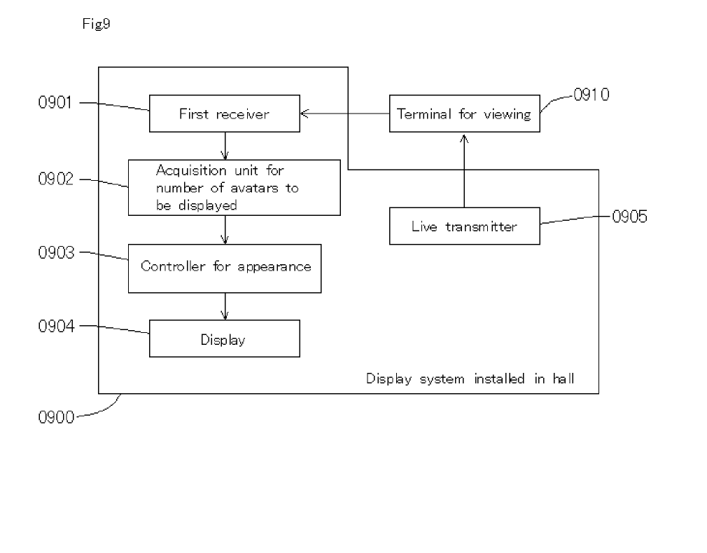

FIG. 9 is a functional block diagram of the display system installed in hall on the basis of the first embodiment. A ‘display system installed in hall’ (0900) comprises a ‘first receiver’ (0901), an ‘acquisition unit for number of avatars to be displayed’ (0902), a ‘controller for appearance’ (0903), a ‘display’ (0904), and a ‘live transmitter’ (0905). The respective components with the exception of the ‘live transmitter’ are the same as those of the first embodiment etc. Accordingly, descriptions thereof have been omitted.

The ‘live transmitter’ has a function of simultaneously transmitting the image of the live performance etc. in the hall to the ‘terminal for viewing’ (0910). The live performance is shot, and transmitted to the terminal for viewing in real time or similar timing, so that the viewer can feel the live performance in a more real way. Moreover, the simultaneously transmitting may be implemented by the movie distribution server, independent from the display system installed in hall.

### Hardware Configuration of Third Embodiment

The display system installed in hall of the third embodiment can be implemented by the hardware configuration described in the first embodiment etc. Accordingly, a description thereof has been omitted.

### Processing Flow of Third Embodiment

The processing flow of the third embodiment further includes a step of transmitting the image of the live performance etc in the hall to the terminal for viewing in addition to the processing flow of the first or second embodiment. For example, at the outset, in response to a transmission request from the terminal for viewing, the image of the live performance etc in the hall is transmitted to the terminal for viewing. Subsequently, the display signal for avatar is received from the terminal for viewing which has received the image. The respective steps from receiving the display signal for avatar to displaying the avatar with controlled appearance are the same as those of the first or second embodiment. Accordingly, descriptions thereof have been omitted.

### Effects of Third Embodiment

According to the third embodiment, it is possible for the viewer to view the live performance etc. in the hall in real time.

### Fourth Embodiment

### Outline of Fourth Embodiment

In a display system installed in hall of a fourth embodiment, the display signal for avatar includes the time information for displaying the avatar, thereby displaying the avatar at a particular time.

### Configuration of Fourth Embodiment

The display system installed in hall of the fourth embodiment is based on any one of the first to third embodiments.

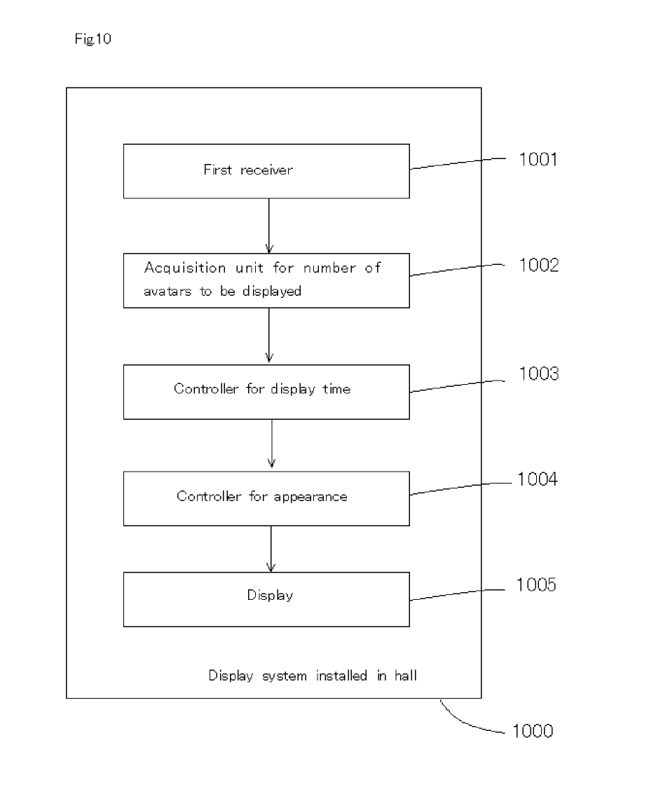

FIG. 10 is a functional block diagram of the display system installed in hall of the fourth embodiment. A ‘display system installed in hall’ (1000) comprises a ‘first receiver’ (1001), an ‘acquisition unit for number of avatars to be displayed’ (1002), a ‘controller for display time’, a ‘controller for appearance’ (1004), and a ‘display’ (1005). The respective components with the exception of the ‘controller for display time’ are the same as those of the first embodiment etc. Accordingly, descriptions thereof have been omitted.

In the fourth embodiment, the ‘display signal for avatar’ received by the first receiver includes the time information for displaying the avatar. This time information may be information to request for the time, at which the viewer wishes to display the avatar of the viewer. For example, when displaying the flower wreath as the avatar, it is possible to display the flower wreath at starting or before starting of live performance etc. in response to the viewer's request. Moreover, when the avatar to be displayed is a flower wreath etc, time information for setting the starting time or the time before starting as the time for displaying may be automatically included without such viewer's request. Moreover, when a concert held in the hall is composed of two parts, any one of the parts may be designated as the time for displaying. Moreover, when receiving the display signal for avatar from the management unit for issuance of ticket, the time information may be included on the basis of number of issuances or sequence of issuances of the tickets.

The ‘controller for display time’ (1004) has a function of controlling display time of the avatar by utilizing time information. The control of display time means, for example, that the avatar is displayed in a time slot, and not displayed in other time slots when the display information designates the time slot where the avatar is to be displayed.

As to the control of avatar's appearance, as shown in FIG. 10, it is assumed that the control of avatar's appearance is executed after the control of display time of the avatar. However, the sequence of controls is not limited to this. Moreover, as to the acquisition of the number of avatars to be displayed, the number of avatars to be displayed may be acquired with respect to each time or time slot by utilizing the time information included in the display information. Moreover, in the functional block diagram of FIG. 10, although the control of the display time is executed after the control of avatar's appearance, the control of the display time may be executed prior to the control of avatar's appearance

### Hardware Configuration of Fourth Embodiment

The display system installed in hall of the fourth embodiment can be implemented by the hardware configuration described in the first embodiment etc. Accordingly, a description thereof has been omitted.

### Processing Flow of Fourth Embodiment

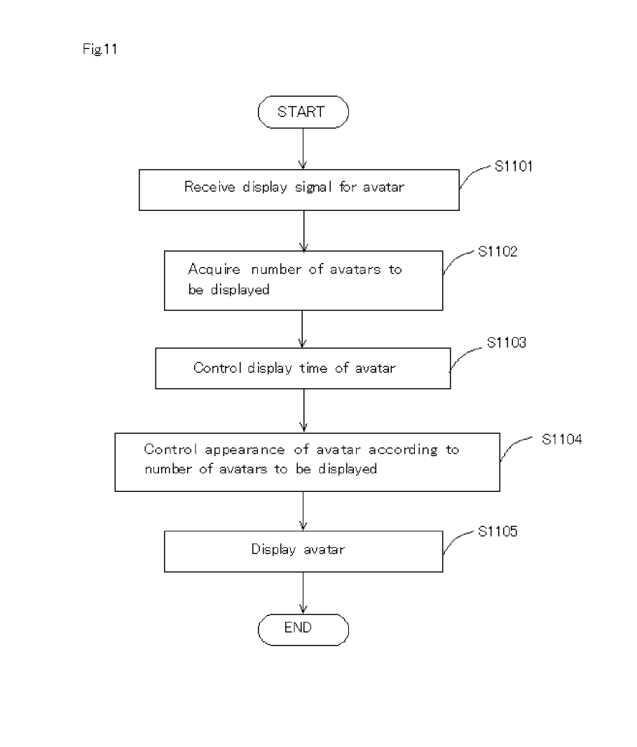

FIG. 11 is a flowchart of the display system installed in hall of the fourth embodiment. The following steps may be executed by the respective hardware components of a computer as described above, or may processing steps composing a program stored in a medium for controlling a computer.

As shown in FIG. 11, at the outset, the display signal for avatar is received (step S1101). This display signal for avatar is transmitted, for example, from the terminal for viewing, the peripheral device for the terminal for viewing, the server for live distribution, or the management server for issuance of ticket. Subsequently, the number of avatars to be displayed of the avatars to be displayed on the display is acquired on the basis of the received display signal for avatar (step S1102). Subsequently, the control of display time of the avatar is executed by utilizing the time information included in the display signal for avatar (step S1103). Subsequently, the control of avatar's appearance is executed according to the acquired number of avatars to be displayed (step S1104). Subsequently, the avatar with the controlled appearance is displayed on the display (step S1105).

### Effects of Fourth Embodiment

According to the fourth embodiment, it is possible to control the timing of displaying avatar, thereby displaying the avatar in response to the viewer's request.

### Fifth Embodiment

### Outline of Fifth Embodiment

In a display system installed in hall of a fifth embodiment, the display time of the avatar is controlled by utilizing priority information for displaying the avatar included in the display signal for avatar. By utilizing the priority information, for example, it is possible to display the avatar of a particular viewer on a priority basis.

### Configuration of Fifth Embodiment

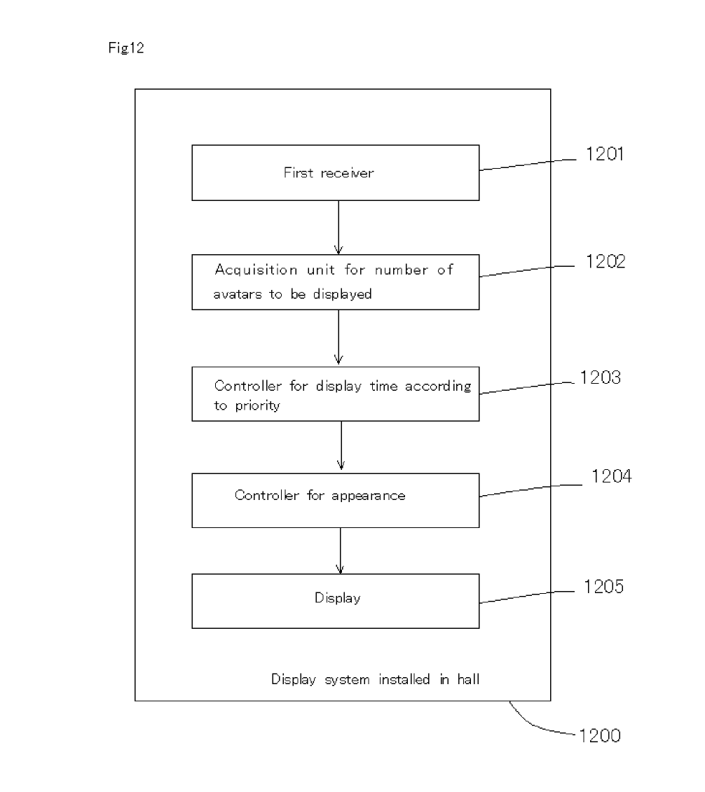

The display system installed in hall of the fifth embodiment is based on any one of the first to fourth embodiments. FIG. 12 is a functional block diagram of the display system installed in hall of the fifth embodiment. A ‘display system installed in hall’ (1200) comprises a ‘first receiver’ (1201), an ‘acquisition unit for number of avatars to be displayed’ (1202), a ‘controller for display time according to priority’ (1203), a ‘controller for appearance’ (1204), and a ‘display’ (1205). The respective components with the exception of the ‘controller for display time according to priority’ are the same as those of the first embodiment etc. Accordingly, descriptions thereof have been omitted.

In the fifth embodiment, the ‘display signal for avatar’ received by the first receiver includes the priority information for displaying the avatar. As to this priority information, a priority may be included according to a sequence of issuances of tickets, or a priority of a certain viewer to other viewers may be included. An example of such viewer having the priority includes a special member or premium member for other general members in the membership-based movie distribution service.

The ‘controller for display time according to priority’ (1203) has a function of controlling display time of the avatar by utilizing priority information. For example, an avatar of the display signal for avatar including a high priority is displayed at the time, where many viewers wish to display the avatars, such as the start or climax of the live performance etc. Moreover, a control may be executed, such that a time, where only the avatar of the display signal for avatar including a predetermined priority is displayed, is provided.

### Hardware Configuration of Fifth Embodiment

The display system installed in hall of the fifth embodiment can be implemented by the hardware configuration described in the first embodiment etc. Accordingly, a description thereof has been omitted.

### Processing Flow of Fifth Embodiment

The processing flow of the display system installed in hall of the fifth embodiment is the same as that of the first or fourth embodiment, and further includes a step of controlling display time of the avatar by utilizing priority information as a processing characteristic of the fifth embodiment.

### Effects of Fifth Embodiment

According to the fifth embodiment, it is possible to control the timing of displaying avatar according to a personal attribute of a viewer such as a viewer who has purchased a ticket early, or a viewer as a special member.

### Sixth Embodiment

### Outline of Sixth Embodiment

In a display system installed in hall of a sixth embodiment, the display time of the avatar is controlled on a basis of a sequence of receiving the display signal for avatar.

This enables grouping according to a sequence of receptions, thereby determining a time slot for displaying avatars with respect to each group.

### Configuration of Sixth Embodiment

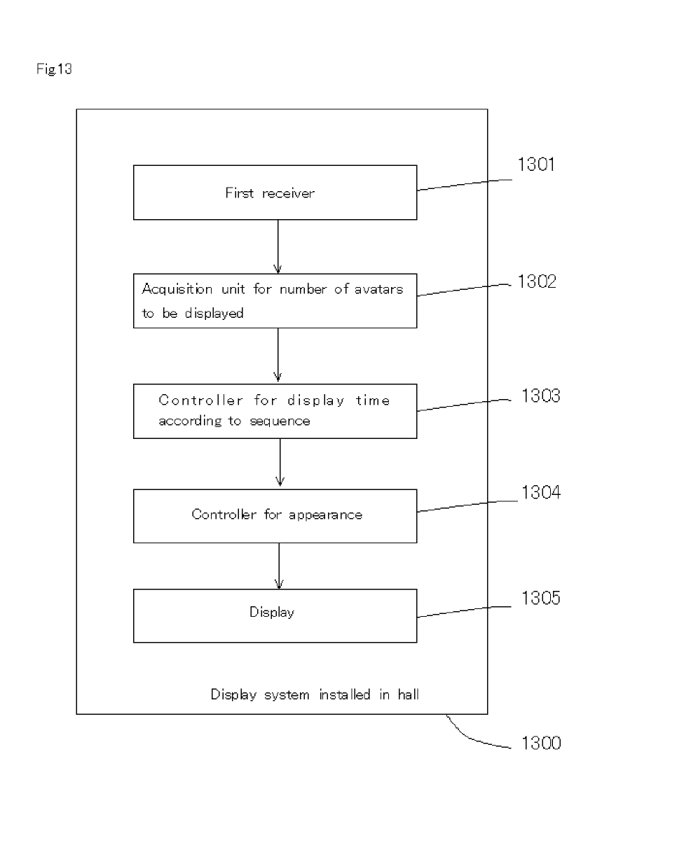

The display system installed in hall of the sixth embodiment is based on any one of the first to fifth embodiments. FIG. 13 is a functional block diagram of the display system installed in hall of the sixth embodiment. A ‘display system installed in hall’ (1300) comprises a ‘first receiver’ (1301), an ‘acquisition unit for number of avatars to be displayed’ (1302), a ‘controller for display time according to sequence’ (1303), a ‘controller for appearance’ (1304), and a ‘display’ (1305). The respective components with the exception of the ‘controller for display time according to sequence’ are the same as those of the first embodiment etc. Accordingly, descriptions thereof have been omitted.

The ‘controller for display time according to sequence’ (1303) has a function of controlling display time of the avatar on a basis of a sequence of receiving the display signal for avatar. The sequence of receptions is attached to the respective display signals for avatar, thereby easily processing the display signals for avatar according to the sequence. For example, when a total number of the received display signals for avatar is 2,000, the received display signals for avatar from 1 to 1,000 are set to be the first group, and 1,001 to 2,000 are set to be the second group. It is possible to control that the avatars of the first group are displayed in the first time slot of the live performance etc, and the avatars of the second group are displayed in the second time slot of the live performance etc. Moreover, when the display signals for avatar further includes the priority information of the fifth embodiment, the control of the display time may be executed based on the sequence of receiving the display signal for avatar and the priority.

### Hardware Configuration of Sixth Embodiment

The display system installed in hall of the sixth embodiment can be implemented by the hardware configuration described in the first embodiment etc. Accordingly, a description thereof has been omitted.

### Processing Flow of Sixth Embodiment

The processing flow of the display system installed in hall of the sixth embodiment is the same as that of the first or fourth embodiment, and further includes a step of controlling display time of the avatar on the basis of a sequence of receiving the display signals for avatar as a processing characteristic of the sixth embodiment.

### Effects of Sixth Embodiment

According to the sixth embodiment, it is possible to control the timing of displaying avatar by utilizing the sequence of receiving the display signal for avatar.

### DESCRIPTION OF REFERENCE NUMERALS

0100 Hall
0101 Stage
0102 Floor
0103 Display
0104 Display
0105 Display
0106 Avatar

1. A display system that is installed in a hall for a live performance, and displays an avatar, the system comprising:
a display, displaying an avatar;
a first receiver, receiving a display signal for avatar from a terminal for viewing or a peripheral device for the terminal for viewing;
an acquisition unit for number of avatars to be displayed, acquiring number of avatars to be displayed on the display on a basis of the received display signal for avatar; and
a controller for appearance, controlling an appearance of the avatar to be displayed on the display according to the acquired number of avatars to be displayed.

2. A display system that is installed in a hall for a live performance, and displays an avatar, the system comprising:
a display, displaying an avatar;
a management unit for issuance of ticket, managing an issuance of a ticket for viewing an image including the live performance in the hall;
a second receiver, receiving a display signal for avatar from the management unit for issuance of ticket;
an acquisition unit for number of avatars to be displayed, acquiring number of avatars to be displayed on the display on a basis of the received display signal for avatar; and
a controller for appearance, controlling an appearance of the avatar to be displayed on the display according to the acquired number of avatars to be displayed.

3. The display system according to claim 1, further comprising:
a live transmitter, simultaneously transmitting the image of the live performance. in the hall to the terminal for viewing.

4. The display system according to 3 claim 1,
wherein the display signal for avatar includes the time information for displaying the avatar,
further comprising: a controller for display time, controlling display time of the avatar by utilizing time information,

5. The display system according to 4 claim 1, further comprising:
a controller for display time according to priority, controlling display time of the avatar by utilizing priority information,
wherein the display signal for avatar includes the priority information for displaying the avatar.

6. The display system according to 5 claim 1, further comprising:
a controller for display time according to sequence, controlling display time of the avatar on a basis of a sequence of receiving the display signal for avatar.

7. A method for operating a display system that displays an avatar on a display in a hall for a live performance, the method causing a computer to execute a process, comprising:
receiving a display signal for avatar from a terminal for viewing or a peripheral device for the terminal for viewing;
acquiring number of avatars to be displayed on the display on a basis of the received display signal for avatar; and
controlling an appearance of the avatar to be displayed on the display according to the acquired number of avatars to be displayed.

8. A method for operating a display system that displays an avatar on a display in a hall for a live performance, and comprises a management unit for issuance of ticket, managing an issuance of a ticket for viewing an image including the live performance in the hall, the method causing a computer to execute a process, comprising:
receiving a display signal for avatar from the management unit for issuance of ticket;
acquiring number of avatars to be displayed on the display on a basis of the received display signal for avatar; and
controlling an appearance of the avatar to be displayed on the display according to the acquired number of avatars to be displayed.

9. A computer-readable storage medium storing a program for causing a computer to execute a process of operating a display system that displays an avatar on a display in a hall for a live performance, the program comprising:
receiving a display signal for avatar from a terminal for viewing or a peripheral device for the terminal for viewing;
acquiring number of avatars to be displayed on the display on a basis of the received display signal for avatar; and
controlling an appearance of the avatar to be displayed on the display according to the acquired number of avatars to be displayed.

10. A computer-readable storage medium storing a program for causing a computer to execute a process of operating a display system that displays an avatar on a display in a hall for a live performance, and comprises a management unit for issuance of ticket, managing an issuance of a ticket for viewing an image including the live performance in the hall, the program comprising:
receiving a display signal for avatar from the management unit for issuance of ticket;
acquiring number of avatars to be displayed on the display on a basis of the received display signal for avatar; and
controlling an appearance of the avatar to be displayed on the display according to the acquired number of avatars to be displayed.
